(19) United States
(12) Patent Application Publication
(10) Pub. No.: US 2015/0236553 A1
(43) Pub. Date: Aug. 20, 2015

(54) SYSTEM FOR LOCKING WIND TURBINE ROTATING ELECTRIC MACHINE SEGMENTS

(71) Applicant: WINDFIN B.V., Leimuiden (NL)

(72) Inventor: Otto Pabst, Rio de Pusteria (IT)

(73) Assignee: WINDFIN B.V., Leimuiden (NL)

(21) Appl. No.: 14/428,307

(22) PCT Filed: Sep. 20, 2013
(86) PCT No.: PCT/IB2013/058714

§ 371 Date: Mar. 13, 2015

(30) Foreign Application Priority Data
Sep. 20, 2012 (IT) MI2012A001569

(51) Int. Cl. H02K 1/18; F03D 9/00; H02K 7/18

(52) U.S. Cl. CPC H02K 1/185; H02K 7/1838; F03D 9/002

(57) ABSTRACT

A system for locking wind turbine rotating electric machine segments has a supporting structure extending about an axis of rotation and having a first mating face, and a plurality of first axial grooves, each communicating with the first mating face; a plurality of segments, each having a second mating face, and a second axial groove which is positioned facing and adjacent to one of the first grooves; and an expansion plug configured to engage a first and second groove facing each other; the first and second groove and the expansion plug being configured so that the expansion plug, when expanded, exerts a force with a radial component to lock the segment to the supporting structure along the respective second and first mating face.

### PRIORITY CLAIM

This application is a national stage application of PCT/IB2013/058714, filed on Sep. 20, 2013, which claims the benefit of and priority to Italian Patent Application No. MI2012A 001569, filed on Sep. 20, 2012, the entire contents of which are each incorporated by reference herein.

### BACKGROUND

Certain known wind turbines employ rotating electric machines of the type in which a rotor rotates about an axis of rotation with respect to a stator. The rotor and the stator comprise respective supporting structures; such as tubular supporting structures, and respective tubular active parts concentric with and facing one another, and fitted to the respective supporting structures. The active parts are separated by a tubular air gap. In this field, segmented active parts, (i.e., active parts divided into a plurality of axial segments), are employed to enable relatively easy assembly, removal, and maintenance of the active parts of the electric machine. Each active segment can be removed and, if necessary, replaced with a new one relatively easily. The tubular active parts are secured to the respective supporting structures, which have respective mating faces for the segments, and axial grooves for guiding and possibly fixing the respective segments in position. U.S. Published Patent Application No. 2010/0123318 A1 and U.S. Published Patent Application No. 2012/0074798 A1 describe two systems for locking segments—in this case, stator segments—to respective supporting structures.

Generally speaking, a segment locking system must ensure relatively extremely precise connection of the segments to the respective supporting structure, so as to form an air gap of constant size both axially and tangentially. Moreover, the segment locking system should, in certain instances, be reversible and relatively easy to handle from one end of the electric machine.

### SUMMARY

The present disclosure relates to a system configured to lock wind turbine rotating electric machine segments.

It is an advantage of the present disclosure to provide a segment locking system that is precise, reliable, and relatively easy to use.

According to the present disclosure, there is provided a system configured to lock wind turbine rotating electric machine segments, the system comprising a supporting structure extending about an axis of rotation and comprising a first mating face, and a plurality of first axial grooves, each communicating with the first mating face; a plurality of segments, each comprising a second mating face, and a second axial groove which is positioned facing and adjacent to one of the first grooves; and an expansion plug configured to engage the first and second groove; the first and second groove and the expansion plug being configured so that the expansion plug, when expanded, exerts a force with a radial component to lock the segment to the supporting structure along the respective second and first mating face.

By virtue of the present disclosure, the radial component provides for locking the segments against the supporting structure with considerable force, which is controllable relatively easily from one end of the electric machine.

In certain embodiments of the present disclosure, each first groove has a first recess bounded by a first projection, and the second groove has a second recess bounded by a second projection; the expansion plug being configured to engage the first and second recess and to exert a force, having a radial component, on the first and second projection.

In other words, the first and second projection are pushed and compressed against each other by the expansion plug.

In certain embodiments of the present disclosure, the first and second groove are aligned along a radial axis; the expansion plug contacting the supporting structure and the segment along inclined faces sloping with respect to the radial axis. The inclined contact faces make it possible to determine a radial component of the force transmitted by the expansion plug.

In certain embodiments of the present disclosure, each first projection has a first inclined face sloping with respect to the radial axis, and the expansion plug has a rib configured to slide along the first inclined face. In other words, the expansion plug slides, with respect to the supporting structure, along the first inclined face as the expansion plug expands. And, as the expansion plug slides, the radial locking force is exerted on the first projection.

In certain embodiments, each second projection has a second inclined face sloping with respect to the radial axis, and the expansion plug has a further rib configured to slide along the second inclined face.

Similarly, the expansion plug slides, with respect to the segment, along the second inclined face as the expansion plug expands. And, as the expansion plug slides, the radial locking force is exerted on the second projection, in the opposite direction to that of the force exerted on the first projection.

In certain embodiments, each first groove has two first recesses bounded by respective first projections and located symmetrically on opposite sides of a radial axis.

In certain embodiments, each second groove also has two second recesses bounded by respective second projections and located symmetrically on opposite sides of a radial axis.

The symmetrical configuration of the recesses provides for transmitting the forces evenly. And the inclined faces generate opposite tangential forces which aid in centering the segment.

In certain embodiments, the expansion plug has a cross section varying in size so as to be insertable loosely inside a first and second groove. This way, the plug need not be forcefully inserted inside the first and second groove. In certain embodiments, the expansion plug extends predominantly in an axial direction along the first and second groove. In other words, the expansion plug extends the whole length of the first and second groove, and exerts axially evenly distributed pressure on the supporting structure and the segment.

In certain embodiments, the expansion plug comprises two lateral bars, each comprising a first and second rib configured to engage a first and second recess. The action of the lateral bars inside the first and second recesses provides for locking the segment.

In certain embodiments, the expansion plug comprises a central bar fitted to the lateral bars so as to slide selectively along planes sloping with respect to the axial direction, and so that slide of the central bar in the axial direction with respect to the lateral bars produces a change in size of the expansion plug in a tangential direction. In other words, the distance between the lateral bars is adjusted by sliding the central bar axially with respect to the lateral bars. Axial slide of the central bar is advantageously controllable from one end of the electric machine.

In certain embodiments, the expansion plug comprises a reversible actuating mechanism configured to slide the central bar in the axial direction with respect to the lateral bars. The actuating mechanism is located at one end of the lateral bars.

In an alternative embodiment, the expansion plug is hollow.

This way, fluid can be fed into the expansion plug to cool the segment, which, as is known, forming part of the active part of the electric machine, produces considerable heat.

In the alternative embodiment, the first and second lateral bar are, in certain embodiments, positioned facing and opposite, and are connected by two permanently deformable walls. This way, the distance between the lateral bars is adjusted by permanent deformation of the deformable walls.

In certain embodiments, each deformable wall comprises two portions at an angle and forming an edge extending in the axial direction. This configuration aids in controlling deformation of the deformable walls.

In certain embodiments, the deformable walls form part of a tube, to which the lateral bars are fixed.

In one variation, the deformable walls are formed integrally with the lateral bars, and together with the lateral bars form a tubular structure. This way, the whole expansion plug may be extruded.

Additional features and advantages are described in, and will be apparent from the following Detailed Description and the figures.

### BRIEF DESCRIPTION OF THE DRAWINGS

A number of non-limiting embodiments of the present disclosure will be described by way of example with reference to the attached drawings, in which:

FIG. 1 shows a partly sectioned side view, with parts removed for clarity, of a wind turbine to which the present disclosure may advantageously be applied;

FIG. 2 shows a larger-scale cross section, with parts removed for clarity, of a rotating electric machine of the FIG. 1 wind turbine;

FIG. 3 shows a partly sectioned view in perspective, with parts removed for clarity, of a first embodiment of the locking system according to the present disclosure;

FIG. 4 shows a partly exploded view in perspective, with parts removed for clarity, of an expansion plug in FIG. 3;

FIG. 5 shows a larger-scale cross section, with parts removed for clarity, of a detail in FIG. 2;

FIG. 6 shows a partly sectioned, smaller-scale plan view, with parts removed for clarity, of the FIG. 3 detail;

FIG. 7 shows a larger-scale plan view, with parts removed for clarity, of a detail in FIG. 6;

FIG. 8 shows a section, with parts removed for clarity, of the FIG. 7 detail along line VIII-VIII;

FIG. 9 shows a schematic cross section, with parts removed for clarity, of the locking system according to the present disclosure;

FIG. 10 shows a partly sectioned view in perspective, with parts removed for clarity, of a locking system in accordance with a second embodiment of the present disclosure;

FIG. 11 shows a larger-scale cross section, with parts removed for clarity, of the FIG. 10 locking system;

FIG. 12 shows a partly sectioned view in perspective, with parts removed for clarity, of a variation of the FIG. 10 locking system; and

FIG. 13 shows a larger-scale cross section, with parts removed for clarity, of the FIG. 12 locking system.

### DETAILED DESCRIPTION

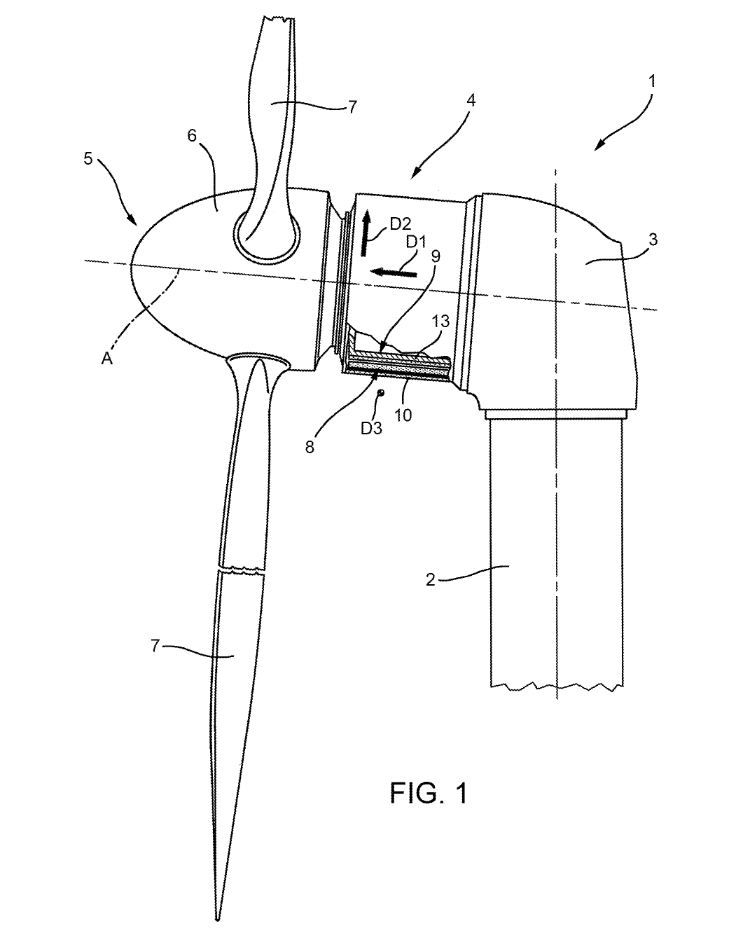

Referring now to the example embodiments of the present disclosure illustrated in FIGS. 1 to 13, number 1 in FIG. 1 indicates as a whole a wind turbine configured to produce electric energy. Wind turbine 1 is a direct-drive type. In the example shown, wind turbine 1 comprises a vertical structure 2; a main frame 3 fitted in rotary manner to the top of vertical structure 2; a rotating electric machine 4; and a blade assembly 5 which rotates about an axis of rotation A. Rotating electric machine 4 is located between main frame 3 and blade assembly 5, and, in addition to producing electric energy, also serves to support blade assembly 5 and to transmit forces and moments induced by blade assembly 5 and rotating electric machine 4 to main frame 3.

In the example shown, main frame 3 is defined by a curved, tubular nacelle.

Blade assembly 5 comprises a hollow hub 6 connected to rotating electric machine 4; and a plurality of blades 7.

Rotating electric machine 4 extends about axis of rotation A, and is substantially tubular to form a passage between the hollow main frame 3 and hollow hub 6. Rotating electric machine 4 comprises a stator 8; and a rotor 9 located inside stator 8, and which rotates with respect to stator 8 about axis of rotation A.

With reference to axis of rotation A, there are defined an axial direction D1 parallel to axis of rotation A; a plurality of radial directions D2 perpendicular to axis of rotation A; and a plurality of tangential directions D3 crosswise to axis of rotation A and to radial directions D2.

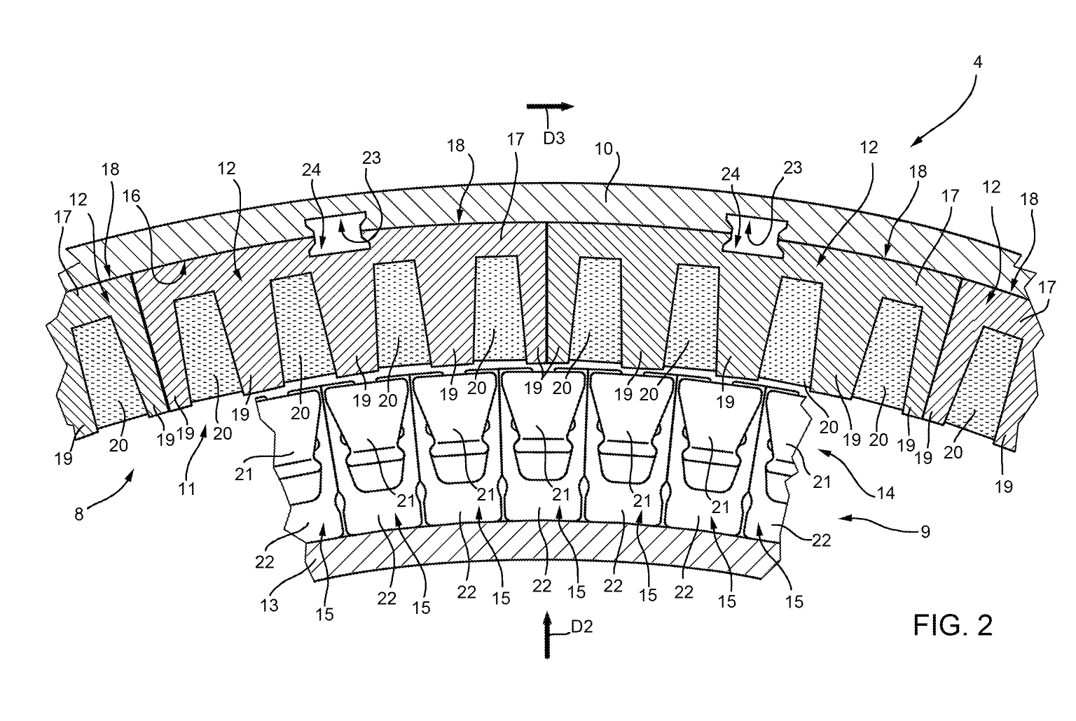

With reference to FIG. 2, stator 8 comprises a tubular supporting structure 10; and a tubular active part 11 comprising a plurality of axial segments 12. Similarly, rotor 9 comprises a tubular supporting structure 13; and a tubular active part 14 comprising a plurality of axial segments 15. As shown in FIG. 1, supporting structure 10 is connected to main frame 3, and supporting structure 13 is connected to blade assembly 5.

Supporting structure 10 has a mating face 16—in the example shown, a cylindrical mating face—along which segments 12 rest. In the example shown, each segment 12 comprises a lamination pack 17, which is substantially prismatic in shape, extends mainly axially, and has a mating face 18 configured to rest on mating face 16, and a plurality of teeth 19 projecting on the opposite side to mating face 18; and a plurality of coils 20 wound about teeth 19 to define field poles.

More specifically, each segment 15 comprises an assembly 21 of magnetic guides and permanent magnets; and a gripper 22 configured to grip assembly 21. Gripper 22 is positioned resting on and fixed to tubular structure 13.

The present description describes a system configured to lock segments 12 to tubular structure 10, though the same principal in general also applies to securing segments 15 to tubular structure 13.

The system configured to lock segments 12 is configured to fix each segment 12 to tubular structure 10 independently of the other segments 12. Accordingly, supporting structure 10 has a plurality of grooves 23, which extend inside the body of supporting structure 10, along mating face 16.

In the example shown, supporting structure 10 has a plurality of grooves 23 equal to the plurality of segments 12. And each segment 12 has a groove 24 configured to face and communicate with a respective groove 23.

In general, the plurality of grooves in each segment depends on the angular extension of the segment and other configuration parameters. As such, each segment may comprise one or more grooves, and the supporting structure has a plurality of grooves equal to a whole multiple of the plurality of segments.

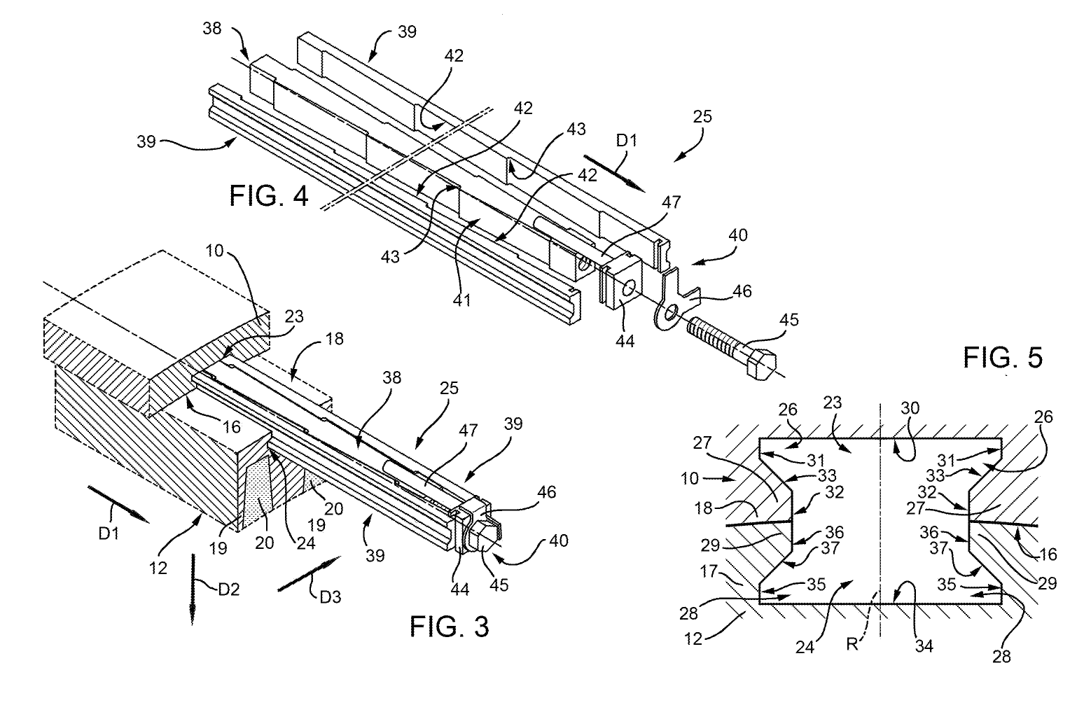

With reference to FIGS. 3 and 4, the locking system also comprises an expansion plug 25 configured to fit inside two facing grooves 23 and 24 to fix segment 12 to supporting structure 10. Expansion plug 25 is configured to expand inside both grooves 23 and 24 and lock segment 12 with respect to supporting structure 10.

With reference to FIG. 5, each pair of grooves 23 and 24 defines an hourglass-shaped cross section substantially symmetrical with respect to a radial axis R. More specifically, groove 23 has two recesses 26 formed respectively by two projections 27 projecting towards radial axis R. Similarly, groove 24 has two recesses 28 formed by two projections 29 projecting towards radial axis R.

Groove 23 has a bottom wall 30 substantially perpendicular to radial axis R; two facing lateral walls 31 adjacent to bottom wall 30 and substantially parallel to radial axis R; two facing lateral walls 32 adjacent to mating face 16 and substantially parallel to radial axis R; and two inclined walls 33 sloping with respect to radial axis R and converging towards the mouth of groove 23. Each inclined wall 33 connects a respective wall 31 to a respective wall 32.

Groove 24 is substantially specular with respect to groove 23, and has a bottom wall 34 substantially perpendicular to radial axis R; two facing lateral walls 35 adjacent to bottom wall 34 and substantially parallel to radial axis R; two facing lateral walls 36 adjacent to mating face 18 and substantially parallel to radial axis R; and two inclined walls 37 sloping with respect to radial axis R and converging towards the mouth of groove 24. Each inclined wall 37 connects a respective wall 35 to a respective wall 36.

With reference to FIG. 4, expansion plug 25 comprises a central bar 38; two lateral bars 39; and an actuating mechanism 40 configured to slide central bar 38 with respect to the lateral bars in axial direction D1. Central bar 38 and lateral bars 39 contact one another along inclined faces 41 and 42, so that slide of the central bar in axial direction D1 parts lateral bars 39 in tangential direction D3, as shown more clearly in FIG. 6.

With reference to FIG. 6, central bar 38 and lateral bars 39 contact one another along a plurality of respective inclined faces 41 and 42, which succeed one another along the whole length of expansion plug 25, slope at the same angle, and alternate with steps 43. This way, a parting force can be transmitted relatively evenly to lateral bars 39 along the whole length of expansion plug 25.

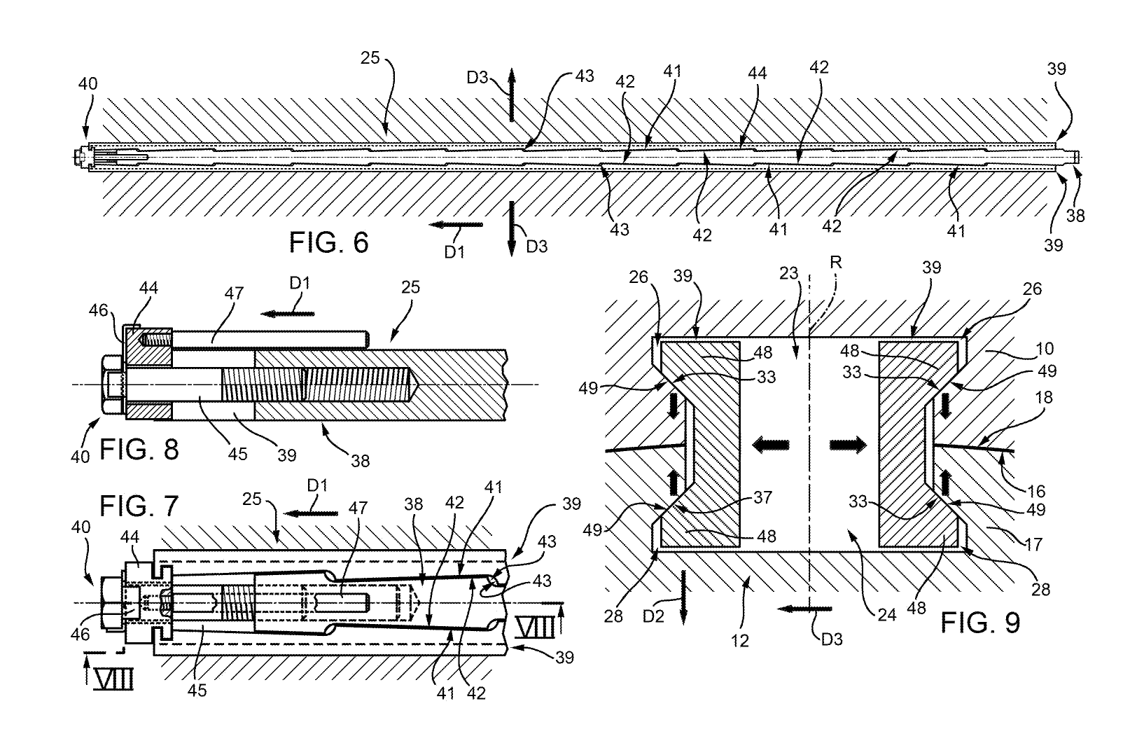

With reference to FIG. 7, actuating mechanism 40, in certain embodiments, comprises a bridge 44 joint-connected directly to lateral bars 39; and a bolt 45, which rotates freely inside bridge 44 and is screwed to central bar 38. Central bar 38 is slid in axial direction D1 with respect to lateral bars 39 by screwing and unscrewing bolt 45.

Actuating mechanism 40 has an anti-back-off device 46 which, in the example shown, comprises a washer with two wings (FIG. 4), one of which is bent onto the head of bolt 45 (FIGS. 3 and 8), and the other of which is bent onto bridge 44.

With reference to FIG. 8, actuating mechanism 40 comprises a pin 47 screwed to bridge 44 and resting on an end portion of central bar 38 to position expansion plug 25.

With reference to FIG. 9, lateral bars 39 of expansion plug 25 are configured to interact with supporting structure 10 and segment 12. Accordingly, each lateral bar 39 is configured to partly occupy one of recesses 26 of groove 23, and the recess 28, specular with respect to said recess 26, of groove 24. Each lateral bar 39 has two ribs 48 configured to engage recesses 26 and 28, and each rib 48 has an inclined face 49 configured to contact inclined face 33 or 37. It should be appreciated that, in certain embodiments, expansion plug 25 is positioned only contacting inclined faces 33 and 37, and exchanges with supporting structure 10 and segment 12 forces perpendicular to inclined faces 33 and 37. The forces exchanged are divided into tangential forces FT, which assist in centering segment 12 with respect to radial axis R of groove 23; and radial forces FR, which press segment 12 against supporting structure 10, along respective mating surfaces 18 and 16.

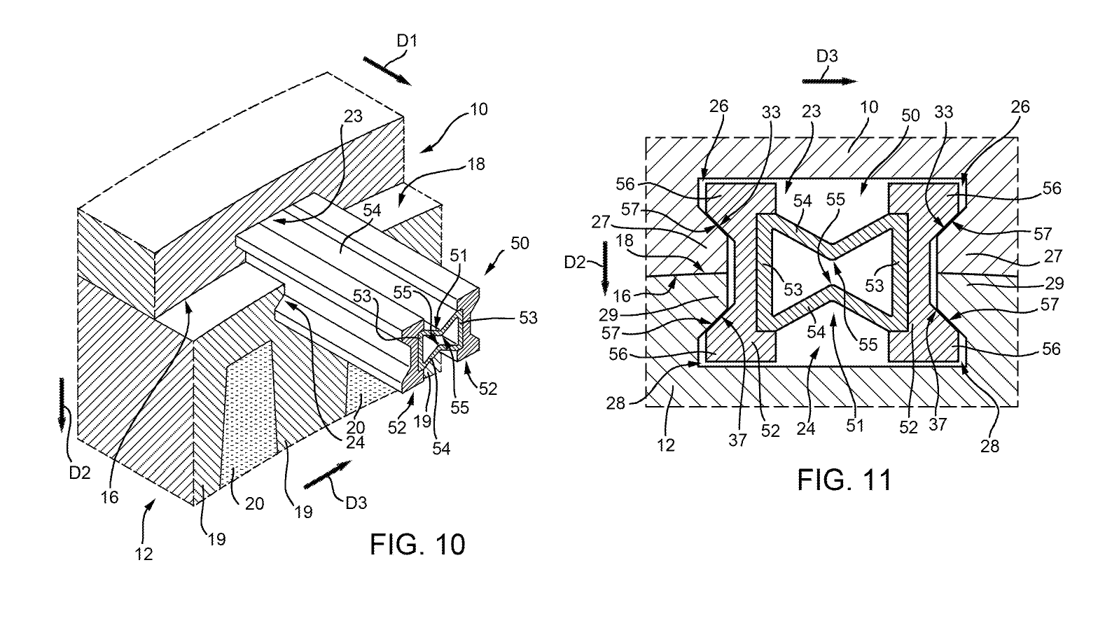

The locking system shown in FIG. 10 employs an expansion plug 50, in lieu of expansion plug 25, to connect segment 12 to supporting structure 10.

Expansion plug 50 interacts with grooves 23 and 24 in the same way as described with reference to FIG. 9, but differs from the FIG. 3 expansion plug 25 in structure, by having no actuating mechanism of its own, and by being configured relatively simply to deform permanently.

In the example shown, expansion plug 50 comprises a deformable tube 51; and two lateral bars 52 fixed on opposite sides of tube 51 and configured to interact with supporting structure 10 and segment 12. Tube 51 has two facing walls 53 fixed to respective lateral bars 52; and two facing walls 54. Each wall 54 is angled to form an edge 55 extending in axial direction D1. In certain embodiments, the edges define the closest portions of walls 54.

Like lateral bars 39, each lateral bar 52 has two ribs 56 configured to engage recesses 26 and 28, and each rib 56 has an inclined face 57 configured to contact inclined face 33 or 37.

In actual use, expansion plug 50 is expanded by permanent deformation of walls 54—in the example shown, by increasing the angle formed by each angled wall. Tube 51 and, in the example shown, walls 54 may be deformed permanently by hydraulic mechanisms or mechanical mechanisms.

Using hydraulic mechanisms, tube 51 is deformed by feeding a liquid inside tube 51, and increasing the pressure high enough to deform tube 51 and fix segment 12 to supporting structure 10.

Mechanical mechanisms are intended to include expansion plugs or wedges (not shown) inserted inside tube 51 to straighten walls 54 of tube 51.

Expansion plug 50 is released by permanent deformation in the opposite direction to that for locking expansion plug 50. To release expansion plug 50, an expansion plug or wedge (not shown in the drawings) is inserted inside the gap between supporting structure 10 and wall 54, and an expansion plug or wedge (not shown in the drawings) is inserted inside the gap between segment 12 and the other wall 54.

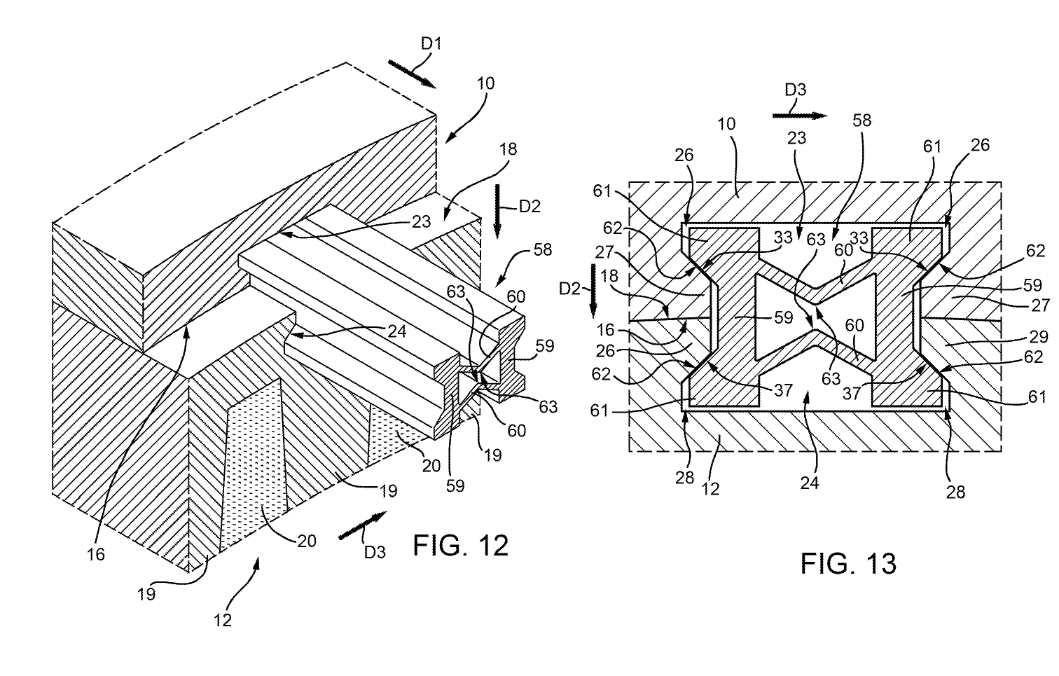

Number 58 in FIG. 12 indicates a variation of expansion plug 50. In this variation, expansion plug 58 is defined by a hollow extruded section, and comprises two facing lateral bars 59, and two facing deformable walls 60 connecting lateral bars 59.

Like lateral bars 39 and 52, each lateral bar 59 has two ribs 61 configured to engage recesses 26 and 28, and each rib 61 has an inclined face 62 configured to contact inclined face 33 or 37.

In certain embodiments, walls 60 are angled and form edges 63 as described for tube 51.

Expansion plug 58 is locked and released in the same way as described for expansion plug 50.

Expansion plugs 50 and 58 are hollow, and are connectable to a cooling gas or liquid source to cool segment 12.

Clearly, changes may be made to the locking system according to the present disclosure without, however, departing from the protective scope of the accompanying Claims. That is, various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1-17. (canceled)

18. A wind turbine rotating electric machine segment locking system comprising:
a supporting structure extending about an axis of rotation, said supporting structure defining:
a first mating face, and
a first axial groove;
a segment defining:
a second mating face, and
a second axial groove which is positioned facing and adjacent to
the first axial groove; and
an expansion plug configured to engage a portion of the supporting structure which defines the first axial groove and a portion of the segment which defines the second axial groove, wherein the portion of the supporting structure which defines the first axial groove, the portion of the segment which defines the second axial groove and the expansion plug are configured such that when the expansion plug is expanded, the expansion plug exerts a force, with a radial component, to lock the segment to the supporting structure along the first mating face and the second mating face.

19. The wind turbine rotating electric machine segment locking system of claim 18, wherein:
the portion of the supporting structure which defines the first axial groove defines a first recess bounded by a first projection,
the portion of the segment which defines the second axial groove defines a second recess bounded by a second projection, and
the expansion plug is configured to:
engage the portion of the supporting structure which defines the first recess and the portion of the segment which defines the second recess, and
exert a force, having the radial component, on the first projection and the second projection.

20. The wind turbine rotating electric machine segment locking system of claim 18, wherein:
the first axial groove and the second axial groove are aligned along a radial axis, and
the expansion plug contacts the supporting structure and the segment along a plurality of inclined faces sloping with respect to the radial axis.

21. The wind turbine rotating electric machine segment locking system of claim 20, wherein:
a projection defined by the portion of the supporting structure which defines the first axial groove defines an inclined face sloping with respect to the radial axis, and
the expansion plug defines a rib configured to slide along the inclined face.

22. The wind turbine rotating electric machine segment locking system of claim 20, wherein:
a projection defined by the portion of the segment which defines the second axial groove defines an inclined face sloping with respect to the radial axis, and
the expansion plug defines a rib configured to slide along the inclined face.

23. The wind turbine rotating electric machine segment locking system of claim 18, wherein the portion of the supporting structure which defines the first axial groove defines two first recesses located symmetrically on opposite sides of a radial axis, each recess bounded by a projection.

24. The wind turbine rotating electric machine segment locking system of claim 23, wherein the expansion plug includes two lateral bars, each lateral bar including a first rib configured to engage the portion of the supporting structure which defines a first of the recesses and a second rib configured to engage the portion of the supporting structure which defines a second of the recesses.

25. The wind turbine rotating electric machine segment locking system of claim 24, wherein the expansion plug includes a central bar fitted to the lateral bars and configured to selectively slide along planes sloping with respect to an axial direction to produce a change in size of the expansion plug in a tangential direction.

26. The wind turbine rotating electric machine segment locking system of claim 25, wherein the expansion plug includes a reversible actuating mechanism configured to slide the central bar in the axial direction with respect to the lateral bars.

27. The wind turbine rotating electric machine segment locking system of claim 18, wherein the portion of the segment which defines the second axial groove defines two recesses located symmetrically on opposite sides of a radial axis, each recess bounded by a projection.

28. The wind turbine rotating electric machine segment locking system of claim 18, wherein the expansion plug has a cross section varying in size so as to be insertable loosely inside the first axial groove and the second axial groove.

29. The wind turbine rotating electric machine segment locking system of claim 28, wherein the expansion plug is hollow.

30. The wind turbine rotating electric machine segment locking system of claim 29, wherein a first lateral bar and a second lateral bar are positioned opposite facing and connected by two permanently deformable walls.

31. The wind turbine rotating electric machine segment locking system of claim 30, wherein each deformable wall includes two portions at an angle and forming an edge extending in an axial direction.

32. The wind turbine rotating electric machine segment locking system of claim 30, wherein the deformable walls form part of a tube to which the lateral bars are fixed.

33. The wind turbine rotating electric machine segment locking system of claim 30, wherein the deformable walls are formed integrally with the lateral bars to form a tubular structure.

34. The wind turbine rotating electric machine segment locking system of claim 18, wherein the expansion plug extends predominantly in an axial direction along the first axial groove and the second axial groove.

35. A wind turbine rotating electric machine segment locking system comprising:
an expansion plug including:
a plurality of lateral bars, and
a central bar fitted to the lateral bars,
wherein the expansion plug is configured to engage a first axial groove defined by a supporting structure extending about an axis of rotation, and a second axial groove defined by a segment, wherein the second axial groove is positioned facing and adjacent to the first axial groove, and a portion of the supporting structure which defines the first axial groove, a portion of the segment which defines the second axial groove and the expansion plug are configured such that when the expansion plug is expanded, the expansion plug exerts a force, with a radial component, to lock the segment to the supporting structure along a first mating face defined by the supporting structure and a second mating face defined by the segment.
